(19) United States
(12) Patent Application Publication
(10) Pub. No.: US 2004/0197758 A1
(43) Pub. Date: Oct. 7, 2004

(54) Magnetically responsive imaging system with display

(76) Inventor: Gordon B. Langford, Sandy, UT (US)

Correspondence Address: Michael W. Starkweather P.C, 8 East Broadway, Suite 600, Salt Lake City, UT, 84111, US

(21) Appl. No.: 10/618,123

(22) Filed: Jul. 11, 2003

Related U.S. Application Data
(60) Provisional application No. 60/395,412, filed on Jul. 12, 2002.

(51) Int. Cl. A63H 33/38; G09B 5/00

(52) U.S. Cl. 434/317; 446/147

(57) ABSTRACT

An imaging system includes a magnetically responsive display. The imaging system includes a first panel, a second panel hingedly connected to the first panel and a plurality of transplant cards that are also hingedly connected to the second panel. A magnetic drawing panel for eraseably forming a magnetic image is mounted on the first panel. A hand operated instrument comparable to a pen or pencil has a magnetic tip which the user employs much like a pen or a pencil to draw an image on the magnetic drawing panel. The instrument is removeably mounted to one of the panels or to some other part of the imaging system. Alternative embodiments of the imaging system include, for example, drawing toys, notebooks, notepads and three-ring binders having a magnetically responsive panel incorporated therein on.

This application is a conversion from provisional application serial No. 60/395,412, filed Jul. 12, 2002.

### BACKGROUND OF THE INVENTION

1. Field of the Invention

The invention is directed to an imaging system, such as a game-tablet or notebook, that employs a magnetically responsive display upon which a user draws or writes using a magnetic pen.

2. Description of the Prior Art

The literature include various designs and methods of constructing panels that employ magnetic materials to form visually perceptible images. For example, in U.S. Pat. No. 4,143,472 (Murata et al.), U.S. Pat. No. 4,536,428 (Murata et al.) and U.S. Pat. No. 4,643,684 (Murata et al.), a magnetic display panel is described as having fine magnetic particles, together with a dispersion medium, sandwiched between a pair of substrates. Another such apparatus is described in U.S. Pat. No. 5,018,979 (Gilano et al.) and U.S. Pat. No. 5,295,837 (Gilano et al.). In U.S. Pat. No. 5,972,493 (Iwasaki et al.) and U.S. Pat. No. 6,299,972 (Iwasaki et al.), a magnetic display sheet is described as having a magnetic powder and dispersion medium encapsulated in gelatin microcapsules, the microcapsules then being sandwiched between a pair of film substrates.

### SUMMARY OF THE INVENTION

An imaging system includes a magnetically responsive display. The imaging system includes a first panel, a second panel hingedly connected to the first panel and a plurality of transparent cards that are also hingedly connected to the second panel. A magnetic drawing panel for eraseably forming a magnetic image is mounted on the first panel. A hand operated instrument comparable to a pen or pencil has a magnetic tip which the user employs much like a pen or pencil to draw an image on the magnetic drawing panel. The instrument is removeably mounted to one of the panels or to some other part of the imaging system. Alternative embodiments of the imaging system include, for example, drawing toys, notebooks, notepads and three-ring binders having a magnetically responsive panel incorporated therein or on.

### BRIEF DESCRIPTION OF THE DRAWINGS

FIG. 1 is a plan view of an imaging system of the present invention;

FIG. 2 is a side view of the imaging system of FIG. 1;

FIG. 3 is a side view of the imaging system of FIGS. 1 and 2, with the magnetically responsive display panel of the imaging system of the present invention partially rotated upward, and with a plurality of transparent cards in different orientations;

FIG. 3A is a perspective view of the game-tablet of the imaging system of FIG. 3;

FIG. 4 is a plan view of the imaging system of FIGS. 1, 2 and 3 with the magnetically responsive display panel and plurality of transparent cards configured for the formation of images relative to a game image;

FIG. 5 is a side view of the imaging system illustrated in FIG. 4;

FIG. 6 is a side view of the imaging system of FIGS. 4 and 5 in an alternate configuration;

FIG. 7 is a side view of the imaging system of FIGS. 1 and 2 in a storage configuration;

FIG. 8 is a partially cut-away plan view of the magnetically responsive display panel of the invention of FIG. 1;

FIG. 9 is an exploded cross sectional view of the magnetically responsive display panel of FIG. 8 taken along the section line 9-9;

FIGS. 10A-C are plan views of an imaging system configured with various theme panels and having a western scene, an underwater scene and an outer-space scene, respectively, that are configured to overlay the magnetically responsive display panel;

FIG. 11 is a perspective view of the theme panel of FIG. 10A;

FIG. 12 is a cross sectional view of FIG. 11 taken along the section line 12-12;

FIG. 13 is a perspective view of a magnetic display notebook containing a magnetically responsive display panel and paper writing sheets;

FIG. 14 is a perspective view of a magnetic display day-planner containing a magnetically responsive display panel and paper writing sheets;

FIG. 15 is a perspective view of a magnetic display three-ring binder containing a magnetically responsive display panel on the inside of the cover;

FIG. 16 is a perspective view of a magnetic display three-ring binder containing a magnetically responsive display panel on the outside of the cover;

FIG. 17 is a perspective view of a magnetic display notepad containing a magnetically responsive display panel on the inside of the cover;

FIG. 18 is a plan view of a drawing toy containing a magnetically responsive display panel;

FIG. 19 is side view of the drawing toy of FIG. 18 taken along the section line 19-19;

FIG. 20 is a plan view of a notebook cover having a magnetically responsive display panel with a vinyl overlay;

FIG. 20A is a view of the notebook cover of FIG. 20 taken along the section 20A-20A;

FIG. 21 is an exploded side view of the notebook cover of FIG. 20 taken along the section line 21-21.

### DETAILED DESCRIPTION OF THE PREFERRED EMBODIMENT

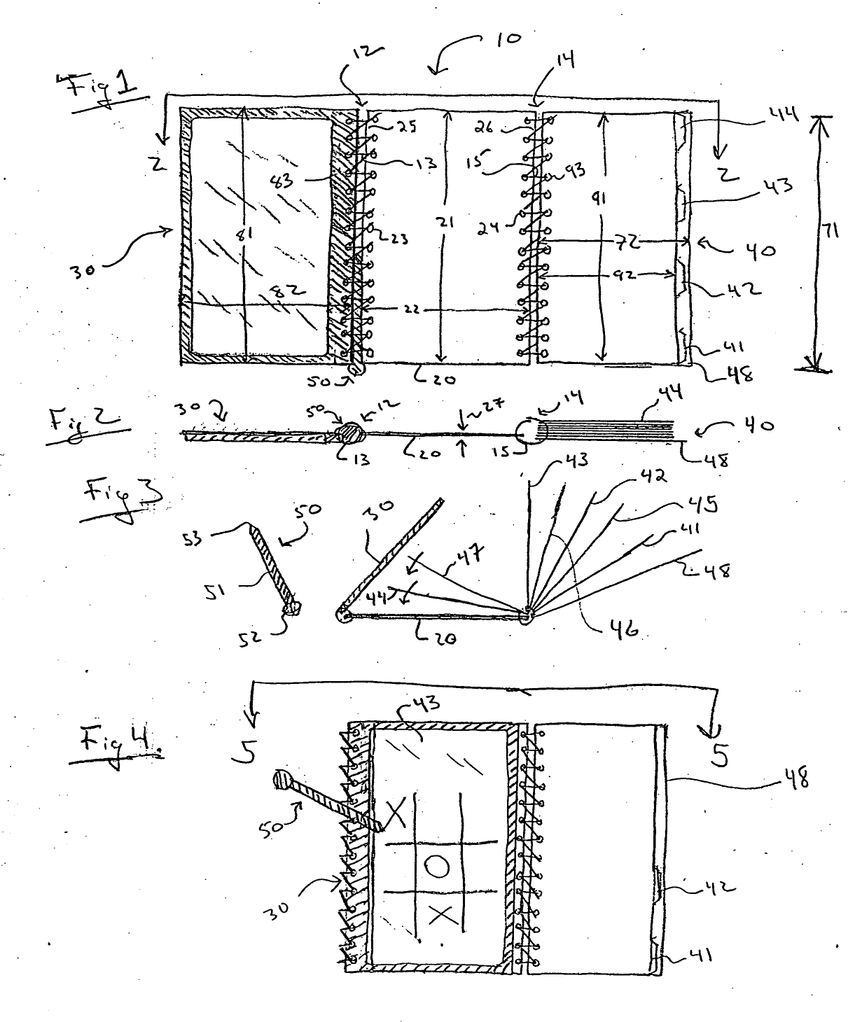

In FIGS. 1 and 2 an imaging system is depicted. The imaging system includes a magnetically responsive display such as magnetic display game-tablet 10. The game-tablet 10 has a center panel 20, a magnetic display panel 30 and a plurality of transparent cards 40. The game-tablet 10 further has a first hinge means 12 for hingedly connecting the center panel 20 and the magnetic display panel 30 and a second hinge means 14 for hingedly connecting the cards 40 with one of the panels 20 or 30. As shown here, the first hinge means 12 hingedly connects the magnetic display panel 30 to the center panel 20. The second hinge means 14 hingedly connects the plurality of transparent cards 40 to the center panel 20. The first hinge means 12 and the second hinge means 14 are illustrated in FIG. 1 as a first wire spiral 13 and a second wire spiral 15, respectively. A hand operated instrument is provided for use in forming images. The instrument includes a magnet for movement over the surface of the magnetic display panel 30. The instrument is shown in FIG. 1 in the shape of a pencil or pen 50 and is frictionally engaged with the first wire spiral 13. It is noted that the magnetic drawing pen 50 may be removably mounted to the game tablet 10 in a variety of other ways. For example, the magnetic drawing pen 50 may be attached to the first wire spiral 13 using a section of string, wire, rubber band, or small gauge chain. Alternatively, the magnetic drawing pen 50 may be removably attached to the center panel 20, for example, by applying one of a hook portion or a pile portion of a hook and pile connector system to some portion of the pen 50 and the other of the hook portion and pile portion to the center panel 20.

The center panel 20 is preferably formed using a stiff, but flexible, material, such as vinyl, plastic or multiple-ply cardboard. The center panel 20 is preferably rectangular in shape, but may assume other shapes as well, such as triangular, elliptical or circular. In the preferred rectangular shape, the center panel 20 has a length 21 and a width 22. The length 21 may be from about three (3) inches to about twenty-four (24) inches, but is, preferably, from about ten (10) inches to about twelve (12) inches. The width 22 may also be from about three (3) inches to about twenty-four (24) inches, but is, preferably, from about seven (7) inches to about nine (9) inches. A first series of holes 23 and a second series of holes 24 are preferably positioned along the left side 25 and the right side 26, respectively, of the center panel 20. The holes 23, 24 are positioned and spaced from one another in a fashion suitable to engage the wire spirals 13, 15. The center panel 20 also has a thickness 27. The thickness 27 will ultimately depend on the material selected to construct the center panel 20—i.e., the stiffer the material, the lesser the required thickness. But for a center panel 20 constructed from vinyl or plastic, thicknesses in the range from about one-thirty-second (1/32) of an inch to about one-eighth (⅛) of an inch are contemplated, with a preferable thickness being about one-sixteenth (1/16) of an inch. The material must be of sufficient rigidity to allow a user to hold it and press upon it to write or draw without any other support.

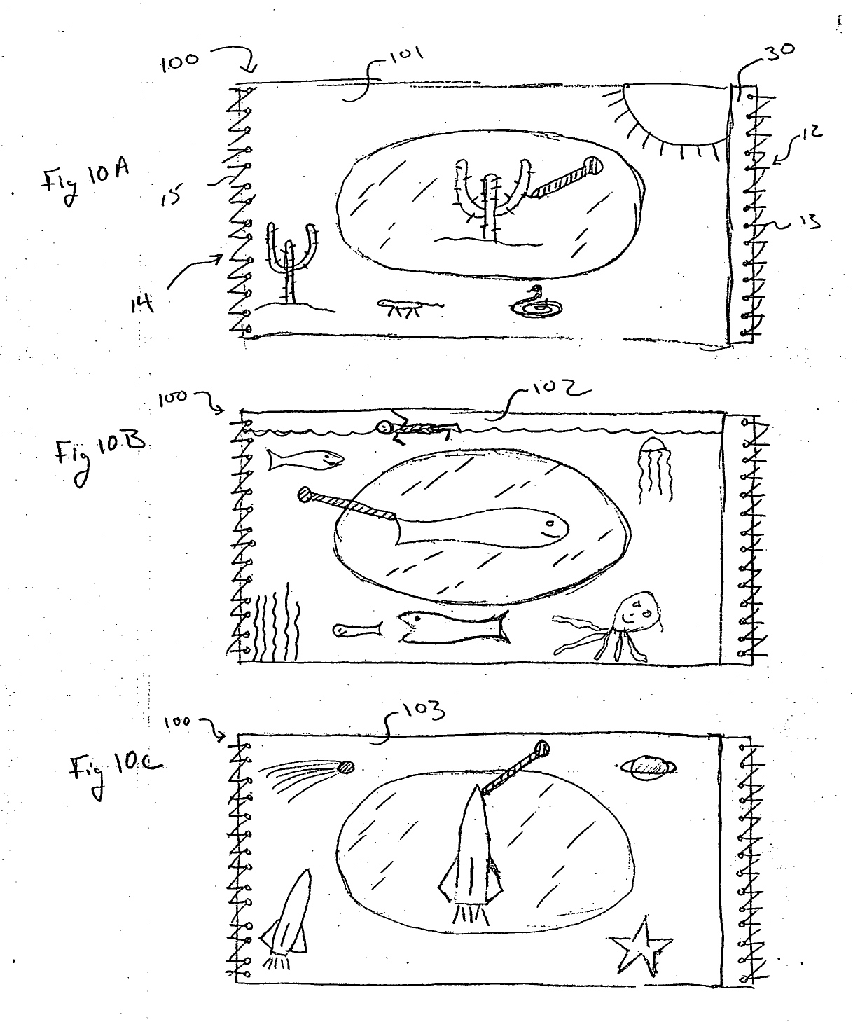

FIGS. 1 and 2 and, more particularly, FIGS. 8 and 9, illustrate various features of a magnetically responsive display panel such as magnetic display panel 30. The magnetic display panel 30 includes a first planar surface 31 and a second planar surface 32 spaced from the first planar surface 31, thereby forming a space or volume 34 therebetween. A dispersion medium 33 is interposed in the volume 34 between the first and second planar surfaces 31, 32. The dispersion medium 33 holds in suspension a plurality of magnetically active flakes 60. A screen member 35 is placed between the first and second planar surfaces 31, 32 and prevents local accumulation of the flakes 60 in the dispersion medium 33 and keeps the dispersion medium distributed throughout the panel. The screen member 35 also resists flow of the dispersion medium 33 across the volume defined by the first and second planar surfaces 31, 32.

The space or volume 34 is formed by spacing the first planar surface 31 from the second planar surface 32 (or vice versa). The spacing 36, or distance between the first and second planar surfaces 31, 32, contemplated with the present invention is from about one tenth of a millimeter (0.1 mm) to about two millimeters (2.0 mm). The preferred embodiment has a spacing 36 of about one-half of a millimeter (0.5 mm) which is roughly equivalent to the thickness of the screen member. It has been found that a spacing 36 that corresponds roughly with the thickness of the screen member 35 provides good drawing and erasing characteristics for the magnetic display panel 30.

The first planar surface 31 is positioned above, or on top of, the second planar surface 32 and is the surface upon which drawing or writing contact with the magnetic drawing pen 50 is made. The first planar surface 31 is preferably constructed from a transparent material, such as clear plastic. If desired, a translucent material may be used in the alternative. In either case, a variety of different plastics or glass can be used. The second planar surface 32 is positioned beneath the first planar surface 31. The second planar surface 32 need not be transparent or translucent. Thus, the second planar surface 32 may be made from a variety of opaque materials, such as single or multi-colored plastics. The thickness of the first and second planar surfaces 31, 32 is preferably from about one-half millimeter (0.5 mm) to about one millimeter (1.0 mm). The thickness may be greater or lesser than the preferred thickness depending on the strength of the magnetic field with which the magnetic display panel 30 is subjected to during writing or drawing.

The first planar surface 31 may be secured to the second planar surface 32 by means of an adhesive over the peripheral edges 37 of the surfaces. Alternatively, the peripheral edges 37 may be secured together through the use of high-frequency welding, ultrasonics or similar processes familiar to those skilled in the art. Securing the first and second planar surfaces 31, 32 together as above indicated, with the dispersion medium 33, the magnetically active flakes 60 and the screen member 35 sealed therein, results in magnetic display panel 30 that is readily activated by a magnetic field.

To provide a greater degree of strength to the magnetic display device 30, a bottom surface or panel 38 is provided. The second planar surface 32 is secured to the bottom surface or panel 38 using any suitable means, such as an adhesive. A top cut-out surface 39 is also provided. The top cut-out surface 39 further provides structural strength for the display panel and is secured to the first planar surface 31 in a fashion similar to that used to secure the second planar surface 32 to the bottom surface 38. The top cut-out surface 39 has a center portion removed to provide drawing and writing access to the first planar surface 31. Both the bottom surface 38 and the top cut-out surface 39 are preferably formed using a stiff, but flexible, material, such as vinyl, plastic or multiple-ply cardboard.

The magnetic display panel 30, as hereinabove described, has a length 81 and a width 82. The length 81 and width 82 are selected preferably to correspond with the length 21 and width 22 of the center panel 20, such that a book-like appearance is provided when the magnetic display panel 30 and the center panel 20 are folded against one another. The preferred embodiment of the magnetic display panel 30 also has a series of holes 83 that span the length of one of the sides. The series of holes 83 are positioned and spaced from one another in a fashion suitable to hingedly engage the first wire spiral 13, that is likewise engaged to the series of holes 23 of the center panel 20.

It is noted here that each of the first planar surface 31, the second planar surface 32 and the bottom surface or panel 38 are sized, preferably, to have the same width 82. As such, the series of holes 83 extend through each of the first planar surface 31, the second planar surface 32 and the bottom surface or panel 38. However, it is contemplated that the bottom surface or panel 38 may, alternatively, have a width somewhat larger in dimension than the width 82 of the first planar surface 31 and the second planar surface 32. The alternative configuration permits the series of holes 83 to extend through the bottom surface or panel 38 only, thereby obviating the need to extend holes through any of the components of the magnetic display panel 30.

The magnetic display panel 30 is shown here to be essentially flat with planar or essentially planar components. It should be understood, however, that the panel may be shaped to be rounded so that it can be envisioned as the exterior surface of a cylinder or sphere. It can also be non-uniform with flat and curved sections or portions as desired for a particular purpose or theme.

FIGS. 1-3 illustrate various features of the plurality of game cards 40. The plurality of game cards 40 provides a series of unique overlays that are individually rotatable onto the magnetic display panel 30. More particularly, the plurality of game cards 40 comprises a number of individual transparencies—e.g., a first transparency 41, intermediate transparencies 42 and 43 and a final transparency 44—that are each hingedly connected to the second wire spiral 15. Each transparency has a game or puzzle imprinted thereon. For example, the transparency 43 that is illustrated overlaying the magnetic display panel 30 in FIG. 4 has the game “tic-tac-toe” imprinted thereon. Any number of transparencies may be used, although the illustrations discussed here generally depict four transparencies 41-44.

If desired, and as illustrated, the plurality of game cards 40 further includes a series of opaque separator sheets 45-47 that are disposed between the transparent cards 41-44 so as to isolate the image on one card from the image on adjacent cards. The separator sheets 45-47 also provide a means to draw directly on the cards, using an erasable marker, without interference from the image on the adjacent cards. In other words, the separator sheets 45-47 provide an opaque background—e.g., a white background—against which the transparent cards may be positioned. This allows one to use an erasable marker—such as an erasable Magic Marker—to draw directly on the transparent card. The separator sheets 45-47 are hingedly connected to the second wire spiral 15 in the same fashion as are the transparent cards 41-44. Any number of separator sheets may be used, although the illustrations generally depict three separator sheets 45-47, with each sheet being sandwiched between a pair of transparent cards.

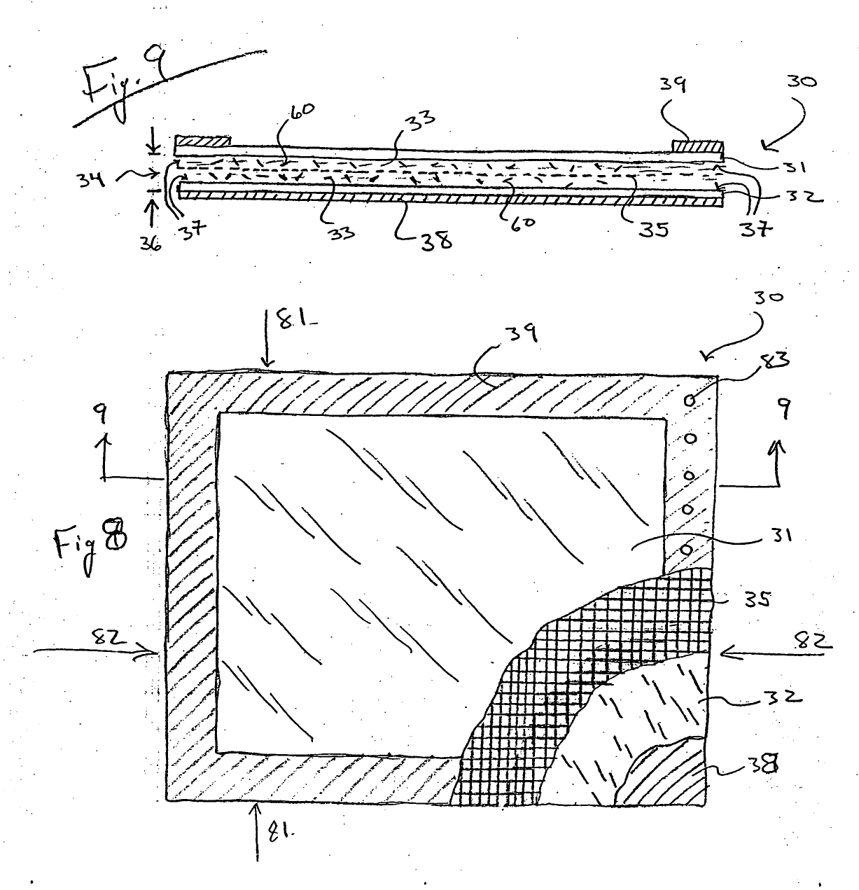

The transparent cards 41-44, together with the separator sheets 45-47, have a length 91 and a width 92. The length 91 and width 92 are selected preferably to correspond with the length 21 and width 22 of the center panel 20, as well as the length 81 and width 82 of the magnetic display panel 20, such that a book-like appearance is provided when the magnetic display panel 30 and the center panel 20 are folded against one another and the transparent cards 41-44 and the separator sheets 45-47 are folded on top of the magnetic display panel 30 (as shown in FIG. 7). The transparent cards and separator sheets have a series of holes 93 for engagement with the second wire spiral 15. The series of holes 93 are positioned and spaced from one another in a fashion suitable to hingedly engage the second wire spiral 15.

A cover card 48 may also be included together with the transparent cards 41-44 and the corresponding separator sheets 45-47. The cover card 48 will also have a series of holes for engagement with the wire spiral. The series of holes in the cover card 48 should correspond with the series of holes 93 that are positioned through the transparent cards 41-44 and the corresponding separator sheets 45-47. The cover card 48 also has a length 71 and a width 72. As with the length 91 of the transparent cards 41-44 and the separator sheets 45-47, the length 71 is selected preferably to correspond with the length 21 of the center panel 20. The width 72 of the cover card 48 is selected preferably to be equal in distance to the width 92 of the transparent cards 41-44 or slightly wider (as illustrated in FIGS. 1-7).

The foregoing describes and illustrates the magnetic display game-tablet 10 as being rectangular in shape, that is, each of the center panel 20, the magnetic display panel 30 and the transparent cards 41-44, the separator sheets 45-47 and the cover card 48 have a length and a width associated therewith. Those skilled in the art will appreciate, however, that the above description is equally applicable to shapes other than rectangular. For example, each of the center panel 20, the magnetic display panel 30 and the transparent cards 41-44, the separator sheets 45-47 and the cover card 48 can be circular, elliptical or triangular in shape, so long as a portion of the respective components includes a region that is configured for the hinged connections as above described. Furthermore, the first wire spiral 13 and the second wire spiral 15 are but examples of the first hinge means 12 and the second hinge means 14, respectively. Other examples of hinge means will be readily apparent to those having skill in the art in the design and construction of means for joining components for relative movement. For example, a series of single wire or plastic clips can be used to hingedly connect the plurality of transparent cards 40 and the magnetic display panel 30 to the center panel 20. A book-like spine could also be used to perform the hinge connecting function. The first and second wire spirals 13, 15 are preferred because they are simple and inexpensive.

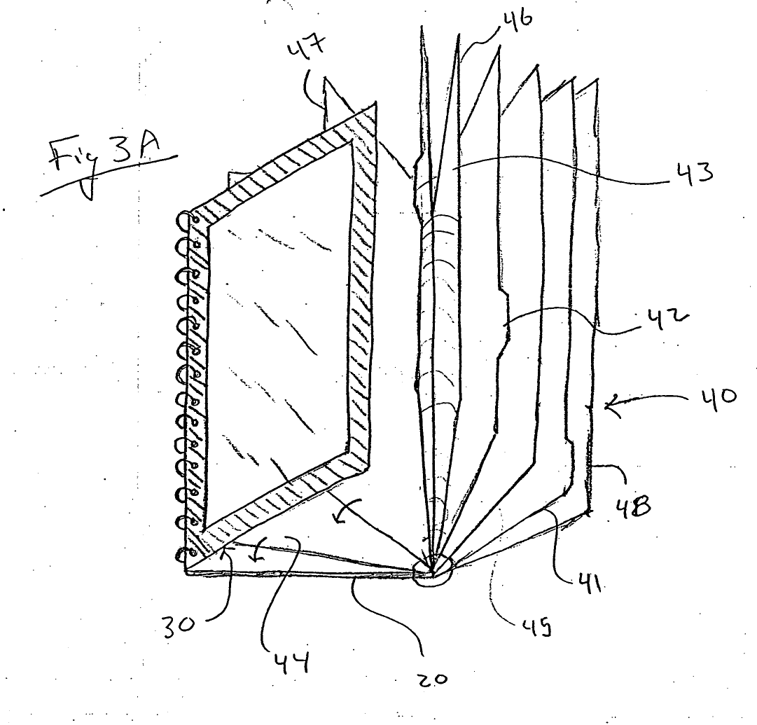

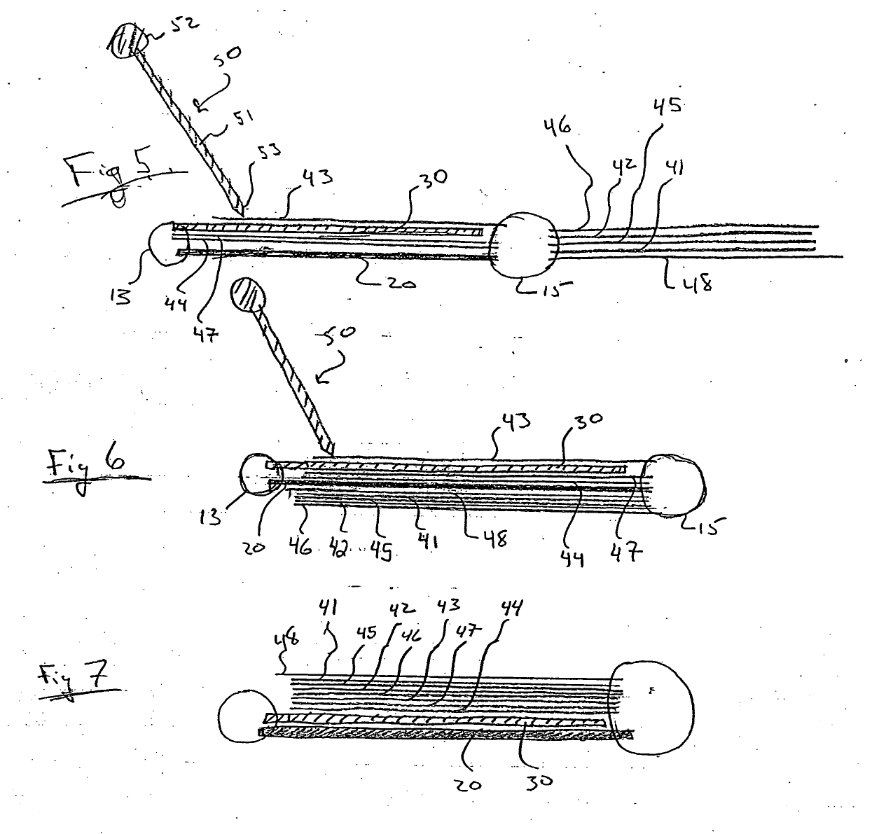

FIGS. 3-7 illustrate certain features of the magnetic display game-tablet 10 that are pertinent to drawing and writing with the magnetic display panel 30 as well as to storage of the game-tablet 10. FIGS. 3 and 3A, for example, illustrate the game-tablet 10 in an open state, where the first transparent card 44 and its corresponding separator sheet 47 are being rotated so as to become sandwiched between the center panel 20 and the magnetic display panel 30. FIGS. 4 and 5 illustrate the game-tablet 10 following rotation of the first transparent card 44 and its corresponding separator sheet 47 onto the center panel 20, followed by rotation of the magnetic display panel 30 so that it rests against the separator sheet 47. FIGS. 4 and 5 further illustrate the next intermediate transparent card 43 resting against the magnetic display panel 30 and, more particularly, resting against the first planar surface 31.

Once a transparent card—e.g., transparent card 43—is resting against the first planar surface 31, the game-tablet 10 is ready to operate by the introduction of a magnetic field that is brought adjacent the transparent card. Specifically, the magnetic pen 50 includes a shaft portion 51, a ball portion 52 and a magnetic tip 53. The magnetic tip 53 is brought into contact with the transparent card—e.g., transparent card 43—that overlays the first planar surface 31 of the magnetic display panel 30. The strength of the magnetic field (gauss) provided by the magnetic tip 53 is such that the magnetically active flakes 60—e.g., nickel, iron or steel particles—are drawn toward the first planar surface 31 or otherwise reoriented beneath the first planar surface 31, thereby causing an image to appear. The image will remain on the magnetic display panel 30 until erased by appropriate means. For example, with the device as above described, erasure occurs when the hand or finger of a user is brought into contact with the first planar surface 31 and is rubbed against the first planar surface 31 so as to re-disperse the magnetically active flakes 60 into the dispersion medium 33.

The magnetically active flakes 60 may be colored—e.g., coated with a metallic substance, such as gold or silver—to enhance the contrast or to provide a particular color effect in conjunction with specific uses of the present invention as described herein and above. The addition of colorants—e.g., pigments or dyes—to the dispersion medium 33 is also contemplated as a means to provide particular color effects. The planar surfaces 31, 32 may also be colored with one or more colors to provide particular effects, as may the images on the transparent cards themselves.

The above description regarding the mechanics of creating an image and erasing the same are not intended to limit the invention as described. Rather, the description is meant only to provide an example of how the imaging system may be constructed with a magnetically responsive display. Further details regarding the creation and subsequent erasure of an image on the magnetic display panel 30, or on a magnetic display panel as is otherwise known in the art of such panels, are described in U.S. Pat. No. 4,143,472 (Murata et al.), U.S. Pat. No. 4,536,428 (Murata et al.) and U.S. Pat. No. 4,643,684 (Murata et al.); U.S. Pat. No. 5,018,979 (Gilano et al.) and U.S. Pat. No. 5,295,837 (Gilano et al.); and U.S. Pat. No. 5,972,493 (Iwasaki et al.) and U.S. Pat. No. 6,299,972 (Iwasaki et al.). The disclosure of each of these patents is incorporated herein by reference.

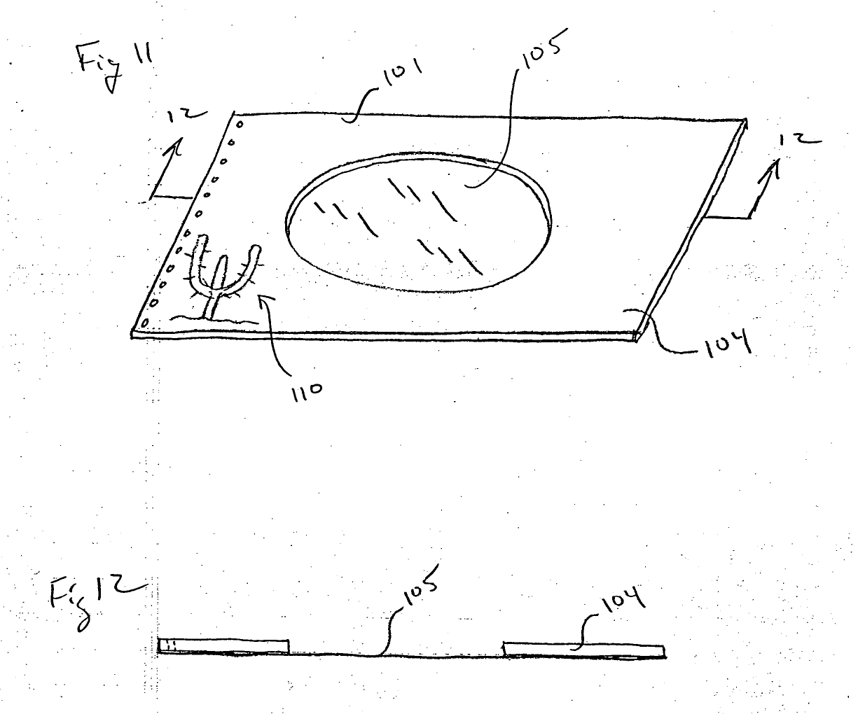

Turning now to FIGS. 10A-C, various embodiments of a drawing toy 100 are illustrated. Specifically, the drawing toy 100 has a center panel 20 and a magnetic display panel 30 as described above with reference to the game-tablet 10. Rather than the plurality of transparent cards 40, etc., however, the drawing toy 100 has a plurality of colored theme panels or drawing images 101-103 that are hingedly connected to the center panel 20. Specific details regarding the construction of each drawing image—e.g., drawing image 101—are illustrated in FIGS. 11 and 12. A transparent card or sheet 105 is overlaid with a front piece 104 that is constructed from plastic, vinyl or cardboard, or from some other suitable material. The front piece 104 has various forms of art work printed thereon. For example, front piece 101 has a desert theme, which includes, among other items, a cactus 110.

A child user may select a specific drawing image—e.g., drawing image 101—and try to replicate the entire theme or just specific items from the theme—e.g., the cactus 110—on the magnetic display panel 30. The positioning of a specific drawing image—e.g., drawing image 101—over the magnetic display panel 30 is accomplished in the same fashion as described above with regard to the game-tablet 10. That is, and as illustrated in FIG. 6, the desired drawing image is rotated about the second hinge means 14 to make contact with the magnetic display panel 30, while the remaining drawing images are rotated either beneath the magnetic display panel 30 or beneath the center panel 20.

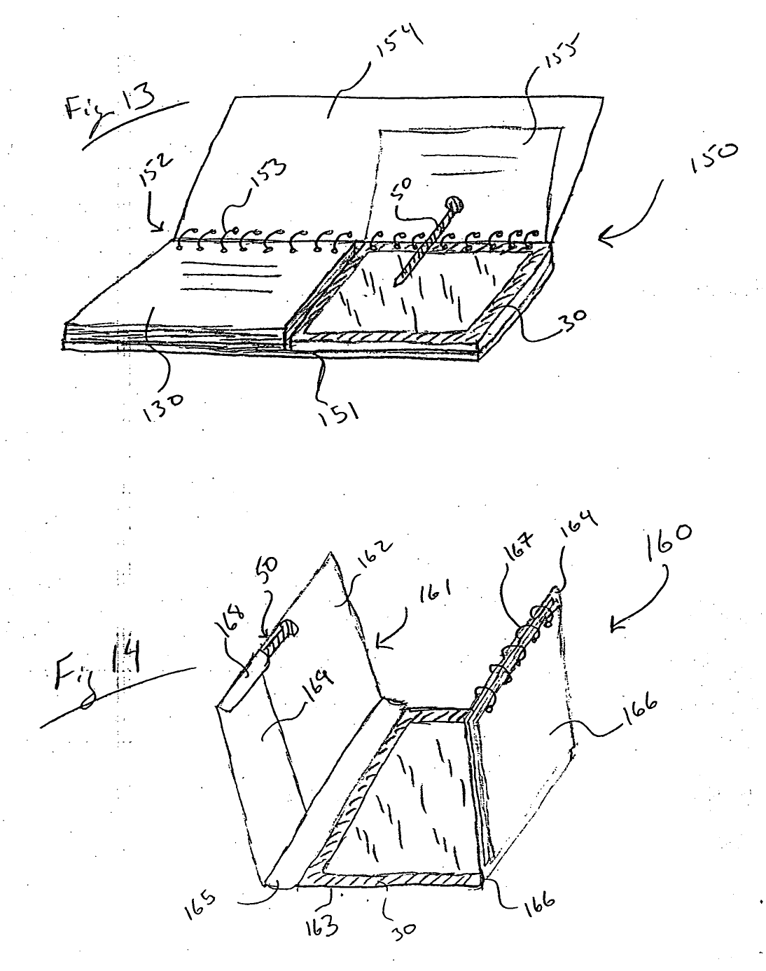

Further alternative embodiments are illustrated in FIGS. 13 and 14. In FIG. 13, for example, a magnetic display panel 30 is combined with a conventional writing tablet 130 to form a combination magnetic display and conventional writing tablet 150. A base panel 151 provides a foundation upon which the conventional writing tablet 130 and the magnetic display panel 30 are mounted. The mounting occurs through a hinge means 152 for hingedly connecting the conventional writing tablet 130 and the magnetic display panel 30 to the base panel 151, which hinge means 152 is illustrated in FIG. 13 as a wire spiral 153. A cover panel 154 is hingedly connected to the base panel 151 in a similar fashion. If desired, a separate cover panel 155 for the magnetic display panel 30 may be provided. The magnetic pen 50 is stored by frictionally engaging the shaft portion 51 with the inside surface of the wire spiral 153.

In FIG. 14, a further alternative embodiment of a combination magnetic display and conventional writing tablet 160 is illustrated. Here, a three-way foundation panel 161 is provided. The three-way foundation panel 161 has a first section 162, a second section 163 and a third section 164. Intermediate sections 165, 166 provide hinge means for hingedly connecting the first, second and third sections to one another. The intermediate sections 165, 166 are illustrated as being formed integrally with the three-way foundation panel 161, but wire spirals could be used in the alternative. A magnetic display panel 30 is mounted to the second section 163 using suitable means, such as through adhesives or stapling. A conventional writing tablet 166 is hingedly connected to the third section 164 through a wire spiral 167. A magnetic pen 50 is removably secured to the first section 162 through a pocket 168 that is formed into the first section 162. If desired, a pouch 169 may be secured to the first section 162 or to the second section 163. The pouch 169 provides a space to store loose papers and the like.

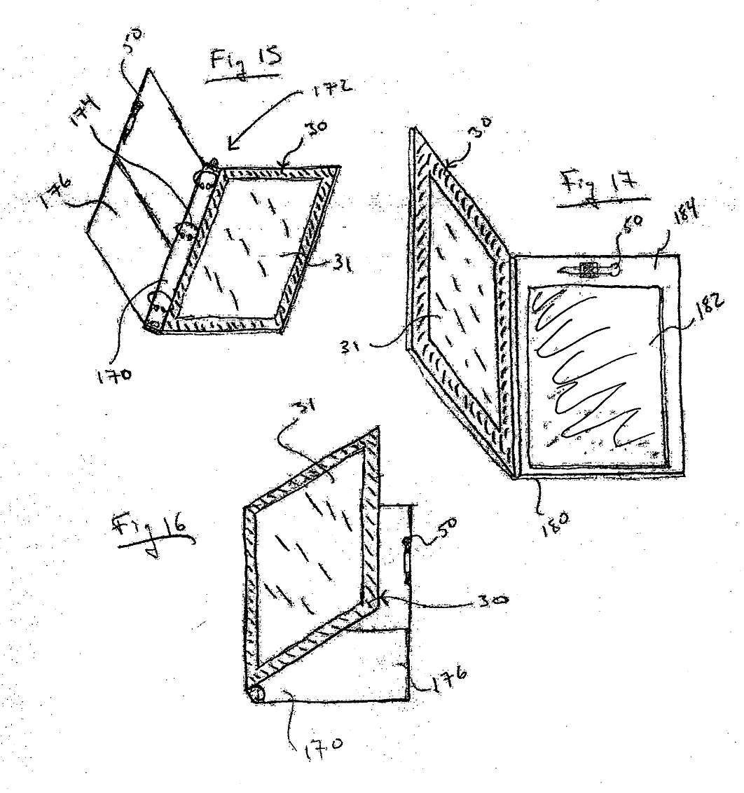

Still further alternative embodiments are illustrated in FIGS. 15-19. In FIG. 15, for example, a magnetic display panel 30 is combined with a conventional three-ring binder 170 to form a combination magnetic display and three-ring binder 172. Here, the magnetic display panel 30 is illustrated as being mounted to the inside surface of one of the covers of the three-ring binder 170. In FIG. 16, the magnetic display panel 30 is illustrated as being mounted to the outside surface of one of the covers of the three-ring binder 170. Any conventional means, such as glue, may be used to mount the magnetic display panel 30 to one of the covers. In each of the foregoing embodiments, paper sheets are storable using both the three-ring loops 174 and the loose-leaf storage pouch 176 of the three-ring binder 170.

A contemplated alternative to the embodiments illustrated in FIGS. 15 and 16 is illustrated in FIG. 20 Here, the magnetic display panel 30 is mounted integrally with and into one of the covers of a typical three-ring binder 170. The top vinyl covering 177 has an opening 177A formed in it to expose the display panel 30. While the opening 177A here shown is scalloped to provide a fanciful appearance, the opening 177A may be formed in a wide variety of shapes or configurations as desired. The panel 30 has an outside edge 30A which is positioned under the covering 177 to retain the panel 30. Further, the vinyl covering 177 is secured snugly in place as it is being welded or otherwise joined to the bottom vinyl covering 178, in turn causing the top vinyl covering 177 to elastically and smoothly deform proximate the outside edge 30A as better seen in FIG. 20A. In turn, a sharp or notable ridge is not formed proximate the outside edge 30A of the panel 30. It is thus believed that wear of the vinyl at or proximate the outside edge 30A will be minimal and thereby extend the useful life of the folder. It may also be noted that the inside edge 177B of the top vinyl covering 177 is beaded to minimize the risk of ripping or tearing the top vinyl covering 177.

In FIG. 21, the top vinyl covering 177 and the bottom vinyl covering 178 typically associated with 3 ring binders surround and secure the outer edge of the magnetic display panel 30 to the cardboard layer 171 which replaces the bottom surface 38 (see FIGS. 8 and 9) or may be used in conjunction therewith. Likewise, the top vinyl covering 177 may be used to replace the top cut-out surface 39 (see FIGS. 8 and 9) or may be used in conjunction therewith.

Referring to FIG. 21, the cardboard layer 171 has a cut-out portion 179 sized and configured to receive the bottom surface 38 of the panel 30, or a portion thereof, for enhanced structural strength. Furthermore, the bottom vinyl covering 178 is positioned adjacent the cardboard layer 171. The first planar surface 31 and the second planar surface 32 are mounted to the bottom surface 38 as previously described. The display panel 30 is then firmly secured between the top vinyl layer 177 and the bottom vinyl layer 178, with the vinyl layers being secured to one another at their edges using any suitable means, such as by gluing or high frequency welding. In any event, glue may also be used to secure the magnetic display panel 30, with or without the bottom surface 38 or the top cut-out surface 39, to one or both of the vinyl coverings 177, 178 and the cardboard layer 171.

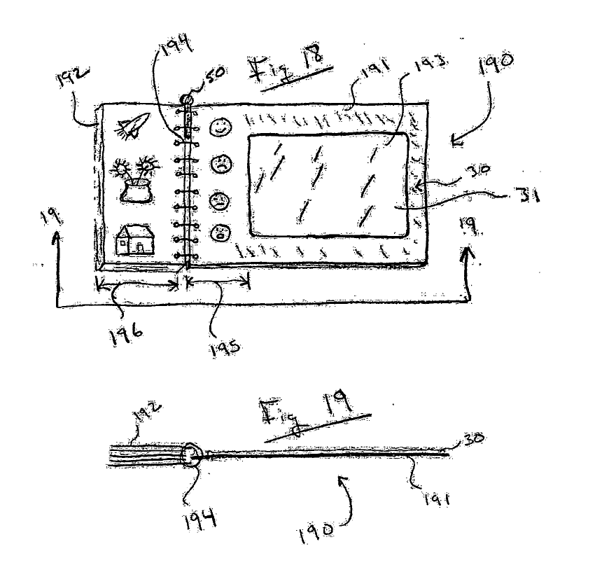

In FIG. 17, a still further embodiment having a magnetically responsive display panel is illustrated. Here, a magnetic display panel 30 is combined with a writing tablet 180. The paper sheets 182 are secured to one of the inside covers of the writing tablet 180 using any conventional means, such a slit in the inside surface of the cover 184 through which the cardboard base of the writing pad is inserted. The magnetic display panel 30 is itself secured to the inside or outside surface of one of the covers, e.g., cover 184, of the writing tablet 180 in a manner similar to those indicated above with regard to the illustrations of FIGS. 15 and 16.

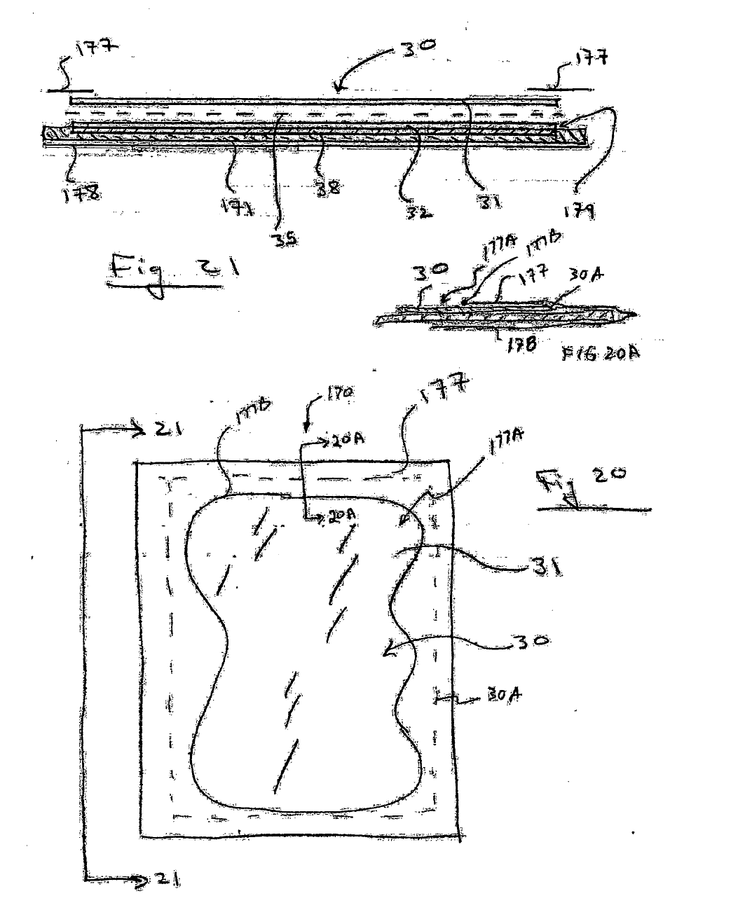

In FIGS. 18 and 19, an alternative to the drawing toy 100 is illustrated. Here, a drawing toy 190 is illustrated having a main panel 191 to which a magnetic drawing panel 30 is mounted using any of the various means described above. A plurality of image cards 192 is hingedly connected to the main panel 191. Each one of the plurality of image cards 192 has an image or a series of images that a user may attempt to replicate on the drawing panel 30. In this embodiment, the screen portion 193 of the drawing panel 30 is offset an offset distance 195 from the wire spiral 194 that is used to secure the plurality of image cards 192 to the panel main 191. The offset allows a user to view two sides of the plurality of image cards 192, without substantially obstructing the screen portion 193. In other words, when one or more of the plurality of image cards 192 is positioned over the main panel 191, the one or more image cards do not overlay a substantial percentage—say, 10 percent or more—of the screen portion 193 of the display panel 30. Consistent with the offset distance 195, each of the plurality of image cards has a width 196, which is selected to be substantially equal—say, within 10 percent—to the offset distance 195. As with the previously described drawing toy 100, various themes may be presented on each one of the plurality of image cards 192. Alternatively, a series of step-by-step drawing instructions may be presented through the plurality of image cards 192 so that a child, for example, might construct a drawing of a complicated object through addition of individual simplified drawing steps.

The imaging system has been described with reference to particular embodiments in the foregoing description. Various other modes for carrying out the invention are, however, contemplated as being within the scope of the claims that follow and that particularly point out and distinctly claim the subject matter which is regarded as the invention.

What is claimed is:

1. An imaging system comprising:
a first panel;
a second panel;
first hinge means for hingedly connecting said first panel to said second panel and for movement of said first panel and said second panel relative to each other;
a plurality of transparent cards;
second hinge means for hingedly connecting said plurality of transparent cards to said second panel and for movement of said second panel and said transparent cards relative to each other;
a magnetically responsive display operable to create an image, said magnetically responsive display being mounted on said first panel and said magnetically responsive display having magnetically responsive material therein;
mounting means for mounting said magnetically responsive display on said first panel; a hand operated instrument for positioning on said magnetically responsive display and movable thereon to form images; and
mounting means for removeably mounting said hand operated instrument to said magnetically responsive display.

2. The imaging system of claim 1, wherein said first panel has a front side, a back side and at least one side edge, wherein said second panel has a front side, a back side and first and second edges, and wherein said first hinge means is configured to hingedly connect said at least one side edge of said first panel to said first edge of said second panel.

3. The imaging system of claim 2, wherein each of said plurality of transparent cards has a front side, a back side and at least one side edge and wherein said second hinge means is configured to hingedly connect said at least one side edge of each of said plurality of transparent cards to said second edge of said second panel.

4. The imaging system of claim 3, wherein said magnetic drawing tablet means has a front side and a back side and wherein the back side of said magnetic drawing tablet means is mounted to the front side of said first panel.

5. The imaging system of claim 4, wherein said first hinge means comprises a first plurality of apertures extending along the at least one side edge of said first panel, a second plurality of apertures extending along the first edge of said second panel, said second plurality of apertures being positioned to correspond with said first plurality of apertures, and a wire spiral that is threaded in alternating fashion through said first plurality of apertures and said second plurality of apertures, said wire spiral defining an inner circumference that is essentially constant along the at least one side edge of said first panel and the first edge of said second panel.

6. The imaging system of claim 5, wherein said magnetic pen means has a first end, a second end spaced from said first end, and a permanent magnet positioned at said first end.

7. The imaging system of claim 6, wherein said magnetic pen means further has a shaft portion with a cross sectional area that is essentially constant between said first end and said second end, and wherein said cross sectional area is sized to frictionally engage with the inner circumference of said wire spiral.

8. The imaging system of claim 7, wherein said second hinge means comprises a third plurality of apertures extending along the second edge of said second panel, a fourth plurality of apertures extending along the at least one side edge of each of said plurality of transparent cards, said fourth plurality of apertures being positioned to correspond with said third plurality of apertures, and a wire spiral that is threaded in alternating fashion through said third plurality of apertures and said fourth plurality of apertures.

9. The imaging system of claim 8, wherein each of said plurality of transparent cards has a unique image printed thereon, and wherein each of said plurality of transparent cards is sized and positioned to overlay the front side of said magnetic tablet drawing means.

10. An imaging system, comprising:
a first panel;
a magnetically responsive display operable to create an image, said magnetically responsive display being mounted on said first panel and having magnetically responsive material therein;
a hand operated instrument for positioning on said magnetically responsive display and movable thereon to form images;
a plurality of image cards hingedly connected to said first panel; and
hinge means for hingedly connecting said plurality of image cards to said first panel.

11. The imaging system of claim 10, wherein said first panel is rectangular in plan form, having a length and a width and an edge along said length, and wherein each one of said plurality of image cards is rectangular in plan for, having a length and a width and an edge extending along said length.

12. The imaging system of claim 11, wherein said hinge means includes a first plurality of apertures extending along said edge of said first panel, a second plurality of apertures extending along said edge of each of said plurality of image cards, said second plurality of apertures being positioned to correspond with said first plurality of apertures, and a wire spiral that is threaded in alternating fashion through said first plurality of apertures and said second plurality of apertures.

13. The imaging system of claim 12, wherein said magnetically responsive display has a screen portion and wherein said screen portion is offset an offset distance from said edge of said first panel.

14. The imaging system of claim 13, wherein the width of each of said plurality of image cards is substantially equal to said offset distance.

15. The imaging system of claim 14, wherein said wire spiral defines an inner circumference that is essentially constant along the edge of said first panel and wherein said hand operated instrument includes a shaft portion that is sized and configured to frictionally engage the inner circumference of said wire spiral.

16. An imaging system, comprising:
a first panel;
a second panel;
first hinge means for hingedly connecting said first panel to said second panel and for movement of said first panel and said second panel relative to each other;
a magnetically responsive display operable to create an image, said magnetically responsive display being mounted on said first panel and said magnetically responsive display having magnetically responsive material therein;
a tablet of writing paper, said tablet of writing paper being mounted to said second panel;
a hand operated instrument for positioning on said magnetically responsive display and movable thereon to form images; and
mounting means for removeably mounting said hand operated instrument to said magnetically responsive display.
